(19) United States
(12) Patent Application Publication
(10) Pub. No.: US 2006/0284867 A1
(43) Pub. Date: Dec. 21, 2006

(54) Web application system, web application server device and web client device

(75) Inventors: Noriyoshi Ishikawa, Yokohama (JP); Jeremy Jay Main, Yokohama (JP); Emiko Kezuka, Yokohama (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 11/220,734

(22) Filed: Sep. 7, 2005

(30) Foreign Application Priority Data
Jun. 21, 2005 (JP) 2005-180271

(51) Int. Cl. G06T 15/00

(52) U.S. Cl. 345/419

(57) ABSTRACT

A screen image for operating a modeling application in a web application server device is displayed in a browser window of a web client device. When an operator inputs an operation related to a three-dimensional model whose CG should be displayed in the screen, the web application server device transmits a drawing command to draw CG of the three-dimensional model to the web client device. The web client device draws CG of the three-dimensional model according to the drawing command through the use of its own graphic accelerator. The invention allows the high-speed drawing of CG of a three-dimensional model on the web client device even when the web application server device provides a modeling service to the web client device.

### BACKGROUND OF THE INVENTION

The present invention relates to a web application system that remotely controls a modeling application in a web application server device through an operation in a web browser window of a web client device. The present invention also relates to a web application server device and a web client device in such a web application system.

It is known fact that a web application server device provides services by an application started on the server side for a web client device through a network.

A conventional web server device provided a CAD (Computer Aided Design) service to make (to draft) a two-dimensional model. A recent web application server device is required to provide a service to make (to model) a three-dimensional model such as 3D CAD and an animation making.

In order to provide such a service with respect to the modeling, the web application server device creates image data such as bitmap data based on CG (Computer Graphics) about the three-dimensional model created by the application, and sends the image data to the web client device. The web client device displays the image of the three-dimensional model viewed from one viewpoint based on the image data.

Incidentally, when a modeling application running on a stand-alone computer changes a viewing direction of a wire-frame model or a surface model of a three-dimensional model and displays it, the computer draws an image in high speed so that the three-dimensional model smoothly changes its orientation. Such a high-speed drawing uses a graphic accelerator integrated in the computer to reduce the load on a CPU of the computer.

However, since the image data is only provided to the web client device, the service provided by the web application server device cannot execute a high-speed drawing of CG such as an orientation changing of a three-dimensional model with a graphic accelerator on the web client device, even if required.

Further, although it can be also conceivable that the web application server device sequentially creates the image data to follow the high-speed drawing of CG, it extremely increases the load on the web application server device and increases the network traffic. As a result, it is considered that the web client device cannot display the three-dimensional model so that its orientation changes smoothly.

### SUMMARY OF THE INVENTION

The present invention is accomplished in view of the problem of the above-described prior art, and the object is to allow the high-speed drawing of CG of a three-dimensional model on a web client device even when a web application server device provides a modeling service to the web client device.

For the above object, according to the present invention, there is provided a web application system that remotely controls a modeling application in a web application server device through an operation in a web browser window of one or more web client devices, the web application server device includes:

a screen image data transmitting section for transmitting screen image data that displays an image of a screen for operating the modeling application to a web client device at a request from the web client device;

an operation receiving section for receiving operation event information showing an operation event input on a screen of the web client device from the web client device;

a drawing command getting section for getting a drawing command to draw CG of a three-dimensional model from the modeling application when the operation event shown by the operation event information received by the operation receiving section relates to the three-dimensional model to be displayed on the screen as CG; and

a drawing command transmitting section for transmitting the drawing command gotten by the drawing command getting section to the web client device, and

the web client device includes:

a request transmitting section for transmitting a request to remotely control the modeling application to the web application server device when an input device accepts the request;

a screen image displaying section for displaying a screen based on screen image data received from the web application server device;

an operation transmitting section for transmitting operation event information that shows an operation event input on the screen to the web application server device when the operation event is detected; and

a CG drawing section for drawing CG of a three-dimensional model in a region where a CG of a three-dimensional model should be drawn in the screen based on the drawing command received from the web application server device.

With this configuration, under the condition where the screen image for operating the modeling application in the web application server device is displayed in the web browser window of the web client device, when an operation is made with respect to the three-dimensional model that is required to display CG in the screen, the web application server device does not transmit the screen image data after drawing the CG of the three-dimensional model to the web client device, but transmits the drawing command to draw the CG of the three-dimensional model to the web client device. This allows the web client device to draw the CG of the three-dimensional model according to the drawing command using its own graphic accelerator.

Further, for the above object, according to the present invention, there is provided a web application server device including:

a screen image data transmitting section for transmitting screen image data that displays an image of a screen for operating a modeling application to a web client device through a communication device when a request is received from the web client device in one or more web client devices connected through the communication device;

an operation receiving section for receiving operation event information showing an operation event input on a screen of the web client device from the web client device through the communication device;

a drawing command getting section for getting a drawing command to draw CG from the modeling application when the operation event shown by the operation event information received by the operation receiving section relates to a three-dimensional model to be displayed on the screen as CG; and

a drawing command transmitting section for transmitting the drawing command gotten by the drawing command getting section to the web client device through the communication device.

Further, for the above object, according to the present invention, there is provided a web client device including:

a request accepting section for accepting a request to remotely control a modeling application of a web application server device connected through a communication device when an operator inputs a request by an input device;

a request transmitting section for transmitting the request accepted by the request accepting section to the web application server device through the communication device;

a screen image displaying section for displaying an image on a screen based on screen image data received from the web application server device through the communication device;

an operation transmitting section for transmitting operation event information that shows an operation event input on the screen to the web application server device through the communication device when the operation event is detected; and

a CG drawing section for drawing CG of a three-dimensional model in a region where a CG of a three-dimensional model should be drawn in the screen based on a drawing command received from the web application server device through the communication device.

As described above, the present invention allows a high-speed drawing of CG of a three-dimensional model in the web client device when the web application server device provides a modeling service to the web client device.

### DESCRIPTION OF THE ACCOMPANYING DRAWINGS

FIG. 1 shows a computer network system of an embodiment of the present invention;

FIG. 2 is a block diagram showing a general configuration of a web client device of the embodiment;

FIG. 3 is a block diagram showing a general configuration of a web application server device of the embodiment;

FIGS. 4 through 7 are flowcharts showing a process executed by a CPU according to a remote control server module;

FIG. 8 shows one example of a data structure of a window management table;

FIG. 9 shows one example of a data structure of a window position management table;

FIG. 10 shows an example screen of a window registered in the window position management table shown in FIG. 9;

FIG. 11 shows rectangular regions obtained by a dividing process;

FIG. 12 is a table showing position information (X-Y coordinate values of the upper-left corner and X-Y coordinate values of the lower-right corner) of the rectangular regions divided by the dividing process;

FIGS. 13 and 14 are flowcharts showing a process executed by a CPU according to a remote control client module; and

FIG. 15 shows a relationship among a transparent plane, a CG drawing plane and an application plane.

### DESCRIPTION OF THE PREFERRED EMBODIMENTS

Hereinafter, an embodiment of the present invention will be described with reference to the attached drawings.

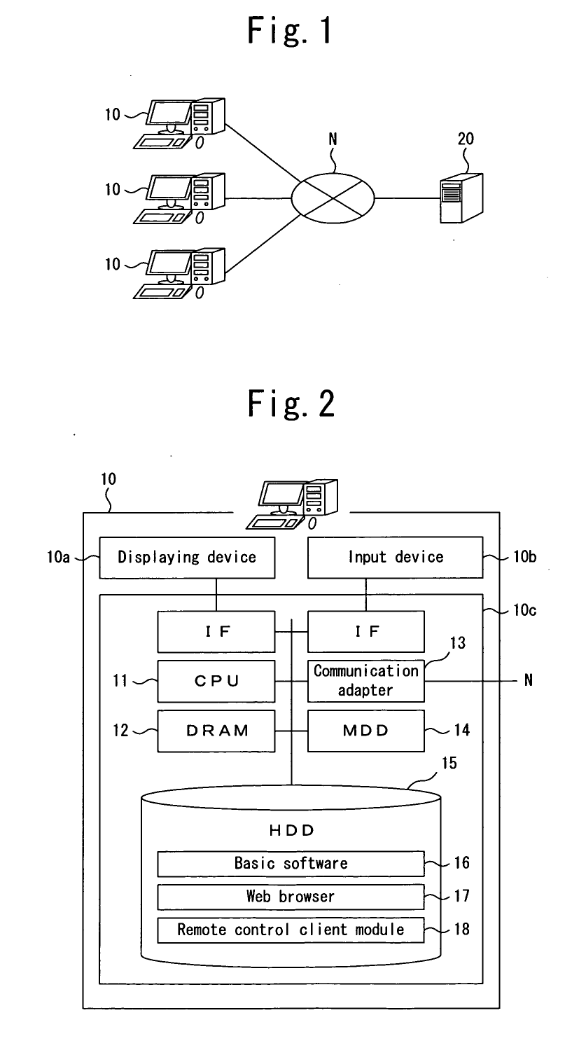

The configuration of a computer network system according to the embodiment will be described first. FIG. 1 shows the configuration of the computer network system of the embodiment.

The computer network system of the embodiment consists of one or more web client devices 10 and a web application server device 20. The devices 10 and 20 are mutually connected through a network N.

The web client device 10 is a commercially available personal computer into which an after-mentioned web browser 17 is installed so as to function as a web client.

The web application server device 20 is a general purpose computer such as a mainframe into which after-mentioned page data 26 and a web server program 27 are installed so as to function as a web server.

FIG. 2 is a block diagram showing a general configuration of the web client device 10.

The personal computer, which configures the web client device 10, consists of a displaying device 10a such as a liquid crystal display, an input device 10b such as a keyboard and a mouse, and a main unit 10c to which these devices are connected.

The main unit 10c includes well-known hardware such as a CPU (Central Processing Unit) 11, a DRAM (Dynamic Random Access Memory) 12, a communication adapter 13, a MDD (Multi Disk Drive) 14, and a HDD (Hard Disk Drive) 15. The HDD 15 stores basic software that provides various basic functions to much application software. The basic functions include an input/output control in the displaying device 10a and in the input device, a communication control in the communication adapter 13 according to the TCP/IP (Transmission Control Protocol/Internet Protocol), and a read/write control for memory areas of the DRAM 12, the MDD 14 and the HDD 15 (memory areas of a memory chip, a CD (Compact Disk), a DVD (Digital Versatile Disk), and a HD (Hard Disk)).

And then, a web browser 17 and a remote control client module 18 are installed in the HDD 15 of the web client device 10.

The web browser 17 is a program to add a function of the web client to a personal computer, and specifically, it is a program to get page data, image data or the like from URL (Uniform Resource Locator) designated by an operator of the web client device 10 and to display web pages, images or the like on the displaying device 10a.

The remote control client module 18 is a program to remotely control applications in the web application server device 20 by the web client device 10. The remote control client module 18 gives the following functions to a personal computer. That is, it gives a function to detect an operation event of a click and a drag of the mouse or a keystroke of the keyboard, a function to acknowledge the information of the operation event to a remote control server module 28 installed in the web application server device 20, and a function to receive a process result output from the application that received the operation event information from the remote control server module 28 and to display it.

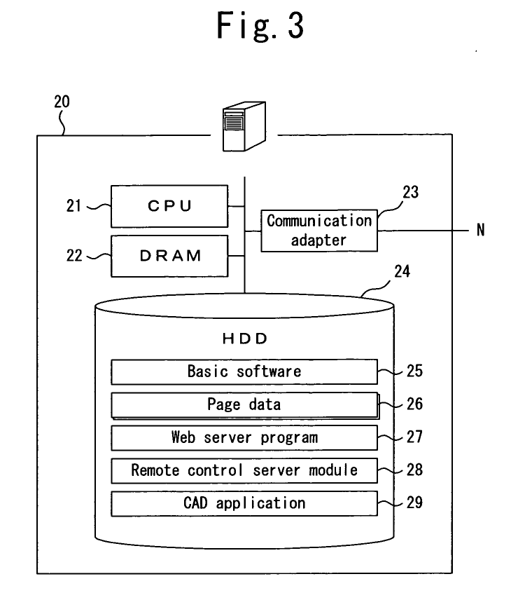

FIG. 3 is a block diagram showing a generic configuration of the web application server device 20.

A general purpose computer that consists the web application server device 20 includes well-known hardware such as a CPU 21, a DRAM 22, a communication adapter 23, and a HDD 24. The HDD 24 stores basic software that provides various basic functions to much application software. The basic functions include a communication control in the communication adapter 23 according to the TCP/IP, and a read/write control for memory areas of the DRAM 22, the HDD 24 (memory areas of a memory chip and a HD).

Page data 26, a web server program 27, a remote control server module 28, and a CAD (Computer Aided Design) application 29 are installed in HDD 24 of the web application server device 20.

The page data 26 includes texts described in a markup language. The page data 26 is prepared for the opening of a web site on the network N, and every page data 26 defines a URL. One of the page data 26 contains a start-instruction command for a CAD application 29 described below.

The web server program 27 is a program for transmitting a requested page data 26 in response to a request from the web client device 10. Further, the web server program 27 requests the start of the application for a remote control server module 28 described below when the page data 26 whose URL is designated by the web client device 10 contains the start-instruction command of the application.

The remote control server module 28 is a program that cooperates with the above-described remote control client module 18 in the web client device 10 to allow an operator of the web client device 10 to remotely control an application in the web application server device 20. The remote control server module 28 gives various functions to the general purpose computer. That is, it gives a function to establish communication with the web client device 10 according to the protocol such as a RDP (Remote Desktop Protocol) or an ICA (Independent Computing Architecture), a function to receive the operation event information from the web client device 10 with which the communication is established, a function to acknowledge the content of the operation event shown by the operation event information to the application, a function to create image data of the screen image that displays the process result of the application, a function to transmit the image data to the remote control client module 18 of the web client device 10 through a RDP communication or an ICA communication.

The CAD application 29 is a program to give at least a function that an operator creates (models) the three-dimensional model on the displaying device to a computer. In addition, the CAD application 29 may also give a function to create (draft) a two-dimensional model to a computer. The three-dimensional model created by the CAD application 29 is displayed on the displaying device as CG (Computer Graphics).

Next, the contents related to the present invention in the process executed on the web application server device 20 will be described.

When an operator of the web client device 10 starts the web browser 17 by operating the input device 10b, the basic software 16 displays a window showing a screen for operating the web browser 17 on the displaying device 10a. The operator inputs URL of the page data 26 including the start-instruction command in a predetermined input field of the screen in the window to instruct access. Then, the web browser 17 (the CPU 11 according to the browser) transmits a request message including the URL to the web server program 27 (the CPU 21 according to the program) of the web application server device 20 through communication according to the HTTP (HyperText Transfer Protocol).

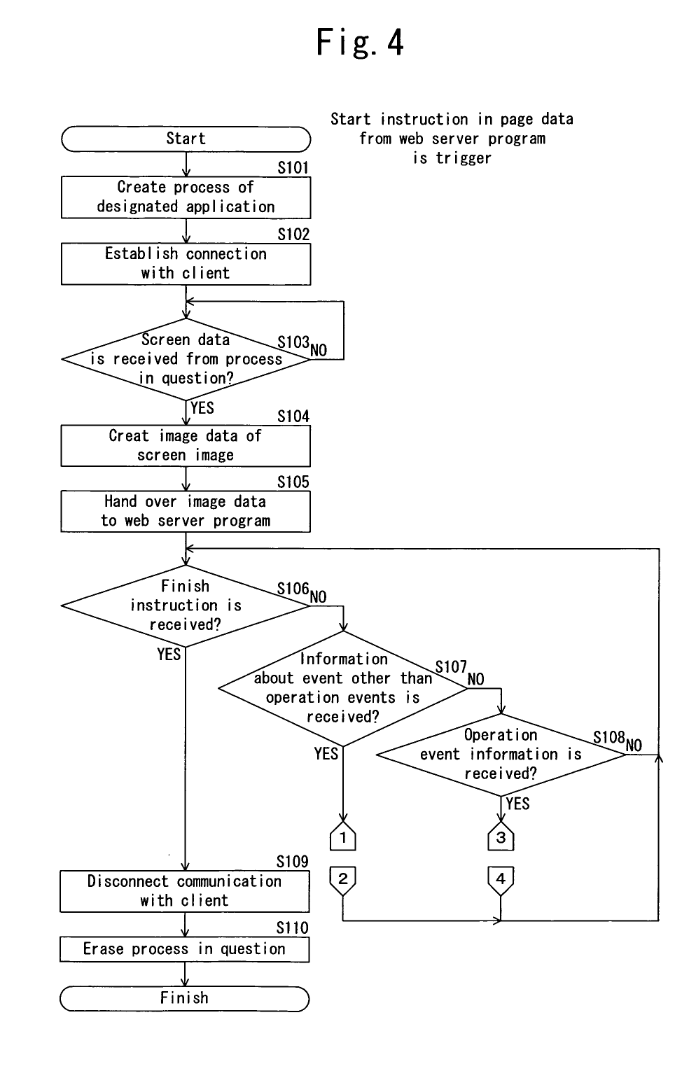

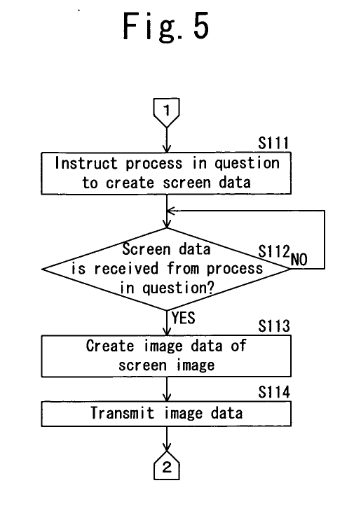

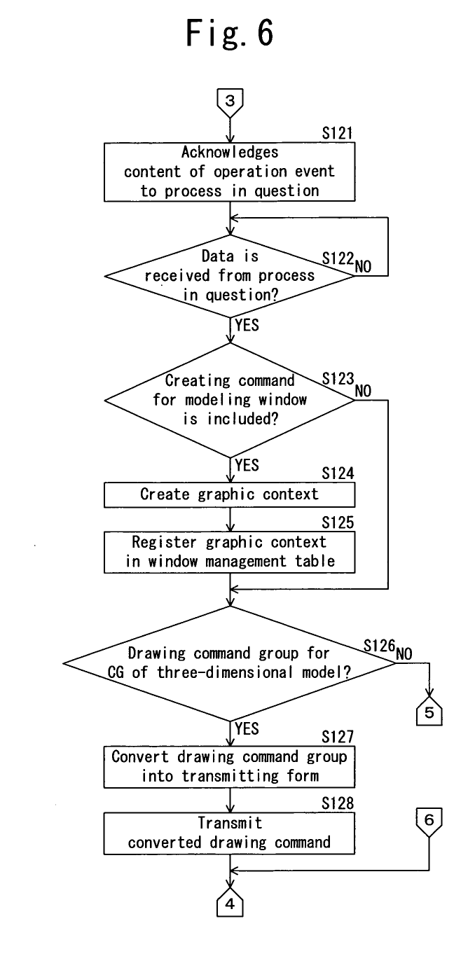

The web server program 27 reads the page data 26 at the URL designated by the request message. And then, when the web server program 27 detects that the page data 26 contains the start-instruction command for the CAD application 29, it becomes a trigger to start the remote control server module 28. FIG. 4 through FIG. 7 are flowcharts showing a process executed by the CPU 21 according to the remote control server module 28.

After starting the process, the remote control server module 28 (the CPU 21 according to the module) allocates a memory area for the web client device 10 and creates the process of the designated CAD application 29 (S101). In the memory area, the information about the window in the displaying, the icons or the like, and the operation event information are also managed. Further, the remote control server module 28 manages creation/deletion of the memory areas allocated for the respective web client devices 10 in a session space in a different memory area.

Next, the remote control server module 28 acknowledges the port number allocated to the CAD application 29 to the remote control client module 18 through a virtual channel and establishes the communication according to the RDP or the ICA with the remote control client module 18 (S102).

After that, the remote control server module 28 waits until the screen data for displaying a screen to operate the CAD application 29 is received from the process created at step S101 (S103; NO).

Receiving the screen data from the process (S103; YES), the remote control server module 28 creates image data of the screen image shown by the screen data (S104), and hands over the image data to the web server program 27 (the function of the CPU 21 according to the program) as data to be embedded to the response message (S105). In addition, receiving the image data, the web server program 27 transmits the response message whose body contains the image data to the web browser 17 of the web client device 10 through the HTTP communication. Receiving the response message, the web browser 17 displays the screen image created by the CAD application 29 based on the image data contained in the response message in the window of the web browser 17. At the time, the web browser 17 arranges a transparent plane to detect a mouse click or a cursor input before the screen image, and waits until any operation event occurs.

The CPU 21 that executes the above-described steps S101 through S105 is equivalent to the screen image data transmitting section described above.

After execution of step S105, the remote control server module 28 waits until reception of a finish instruction of the CAD application 29 from the web client device 10, reception of the information about an event other than the operation events, or reception of the operation event information about a click, a drag, or a key input (S106; NO, S107; NO, S108; NO). The events other than the operation events includes, for example, an event that the remote control client module 18 requests image data of the screen image created by the CAD application 29. When the window of the different application was overlapped on the window of the web browser 17 and then the window of the web browser 17 is again displayed over the other window in the web client device 10, a part of the screen image created by the CAD application that is overlapped with the window of the web browser 17 will be chipped. In such a case, the remote control client module 18 requests the image data to display the screen image again.

When the finish instruction is received from the web client device 10 through the RDP communication or the ICA communication (S106; YES) during the process loop's execution (S106; NO, S107; NO, S108; NO), the remote control server module 28 disconnects the communication with the remote control client module 18 (S109), erases the process in question (S110), and finishes the process in FIG. 4 through FIG. 6.

Further, when information about an event other than the operation events is received from the web client device 10 through the RDP communication or the ICA communication (S107; YES) during the process loop's execution (S106; NO, S107; NO, S108; NO), the remote control server module 28 instructs the process in question to create screen data for displaying a screen of the CAD application 29 (S111), and waits until the screen data is received from the process in question (S112; NO). After that, receiving the screen data (S112; YES), the remote control server module 28 creates the image data of the screen image shown by the screen data (S113), transmits the image data to the remote control client module 18 of the web client device 10 through the RDP communication or the ICA communication (S114), and restarts the process loop (S106; NO, S107; NO, S108; NO). Further, receiving the image data, the remote control client module 18 hands over the image data to the web browser 17 and the web browser 17 displays the screen image based on the image data in the window for the web browser 17.

Further, when the operation event information is received from the web client device 10 through the RDP communication or the ICA communication (S108; YES) during the process loop's execution (S106; NO, S107; NO, S108; NO), the remote control server module 28 acknowledges the content of the operation event to the process in question (S121). In addition, the CPU 21 that executes the step S108 is equivalent to the above-described operation receiving section.

After that, the remote control server module 28 waits until it receives the response data, that is, the process result obtained by executing the process according to the operation event, from the process in question (S122; NO). The CAD application 29 leaves the process for drawing CG of a three-dimensional model to the remote control server module 28. In this case, the CAD application 29 hands over the command group of the Open GL, for example, for drawing CG of a three-dimensional model to the remote control server module 28. Further, the CAD application 29 executes processes other than the process for drawing CG of a three-dimensional model by itself. In this case, the CAD application 29 creates a window for making (drafting) a two-dimensional model displayed based on the operation event or window contents data for displaying GUI (Graphical User Interface) parts, and hands over the window contents data to the remote control server module 28.

Then, receiving the data from the process in question (S122; YES), the remote control server module 28 determines whether the data includes a creating command for creating a modeling window for a three-dimensional model or not (S123).

If the data received from the process in question includes the creating command for creating the modeling window (S123; YES), the remote control server module 28 creates graphic context defining that the three-dimensional model will be drawn in the window by the command group included in the data (S124), and registers the graphic context in the window management table (S125).

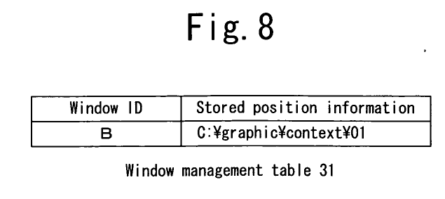

Specifically, the process in question assigns window ID's for all the windows in the screen for operating the CAD application 29 as identifying information to individually identify the windows. The remote control server module 28 gets the window ID of the modeling window from the process in question. Next, the remote control server module 28 registers a record that includes the window ID and the information showing the stored position of the created graphic context into the window management table. FIG. 8 shows one example of the data structure of the window management table 31. As shown in FIG. 8, the window management table 31 contains records as many as all the modeling windows in the screen for operating the CAD application 29. Each of the records has fields of “window ID” and “stored position information”. The window ID of the modeling window is stored in the “window ID” field, and the information showing the stored position of the graphic context is stored in the “stored position information”.

Registering the graphic context in the window management table 31 as shown in FIG. 8, the remote control server module 28 determines whether the data received from the process in question includes the drawing command group for drawing CG of a three-dimensional model in the modeling window or not (S126).

On the other hand, if the creating command group is not included in the data received from the process in question (S123; NO), the remote control server module 28 determines whether the data received from the process in question includes the drawing command group for drawing CG of a three-dimensional model in the modeling window or not (S126) without creating and registering graphic context.

When the data received from the process in question includes the drawing command group for drawing CG of a three-dimensional model in the modeling window (S126; YES) the remote control server module 28 converts the drawing command group into a transmitting form so as to transmit by an original protocol (S127). An individual transmitting form is previously defined to each of the graphic-related commands. The remote control server module 28 converts the graphic-related commands into the transmitting forms according to the definitions. For example, a command V having attribute values p, q is converted into a record (1, p, q), and a command W having attribute values r, s, t is converted into a record (2, r, s, t).

The CPU 21 that executes steps S122 and S126 is equivalent to the above-described drawing command getting section.

Next, the remote control server module 28 transmits the drawing command group converted into the transmitting form according to the original protocol to the remote control client module 18 (S128), and restarts the above-described process loop (FIG. 4, S106; NO, S107; NO, S108; NO).

On the other hand, if the data received from the process in question does not include the drawing command group for drawing CG of a three-dimensional model in the modeling window (S126; NO), the data only includes the window contents data for displaying a drafting window or GUI parts. Therefore, the remote control server module 28 creates image data of image of the window (a drafting window or GUI parts) defined by the window contents data (S131).

Next, the remote control server module 28 reads the position information, which shows the position where the window should be located, from the window contents data, and transmits the image data and the position information to the remote control client module 18 of the web client device 10 through the RDP communication or the ICA communication (S132). Receiving the image data and the position information, the remote control client module 18 hands over the image data to the web browser 17. The web browser 17 displays the screen image based on the image data at the position defined by the position information in the operation screen of the CAD application 29.

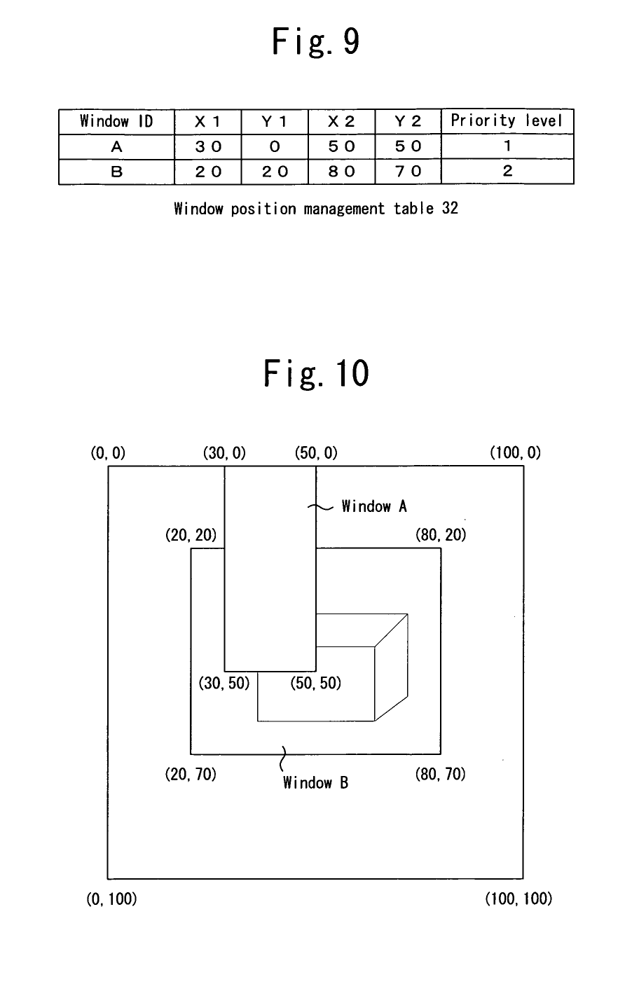

After that, the remote control server module 28 gets a window position management table, which is used by the process in question to manage all the windows in the operation screen of the CAD application 29, from the process in question (S133). FIG. 9 shows one example of the data structure of the window position management table 32. As shown in FIG. 9, the window position management table 32 contains records as many as all the windows in the screen for operating the CAD application 29. Each of the records has fields of “window ID”, “X1”, “Y1”, “X2”, “Y2”, and “priority level”. The window ID is stored in the “window ID” field. The windows described here include GUI parts such as drop-down list boxes and tool boxes as well as the modeling windows and the drafting windows. The X coordinate and Y coordinate of the upper-left corner of the window are stored in the “X1” field and “Y1” field, respectively. In the same manner, the X coordinate and Y coordinate of the lower-right corner of the window are stored in the “X2” field and “Y2” field, respectively. The priority level of the window is stored in the “priority level” field. When a plurality of windows are overlapped, the window whose priority level is smaller is displayed before the other window.

After getting the window position management table 32 from the process in question, the remote control server module 28 determines whether any window defined by the window contents data from the process in question hides the other window in the operation window of the CAD application 29 or not (S134)

If no window is hidden by the window defined by the window contents data is displayed before the other windows in the operating screen of the CAD application 29 (S134; NO), the remote control server module 28 restarts the above-described process loop (FIG. 4, S106; NO, S107; NO, S108; NO).

On the other hand, if a part of the window is hidden by the window defined by the window contents data in the operation screen of the CAD application 29 (S134; YES), the remote control server module 28 determines whether the partially hidden window includes the modeling window or not (S135).

When the window that is partially hidden by the window defined by the window contents data does not include the modeling window (S135; NO), the remote control server module 28 restarts the above-described process loop (FIG. 4, S106; NO, S107; NO, S108; NO).

On the other hand, when the window that is partially hidden by the window defined by the window contents data includes the modeling window(s) (S135; YES), the remote control server module 28 specifies the modeling windows one by one as a target and executes the following process for each modeling window (S136, S139; NO).

That is, specifying one modeling window as a target (S136), the remote control server module 28 refers the window position management table to divide the region that is not hidden by the other windows of the target window into a plurality of rectangular regions (S137).

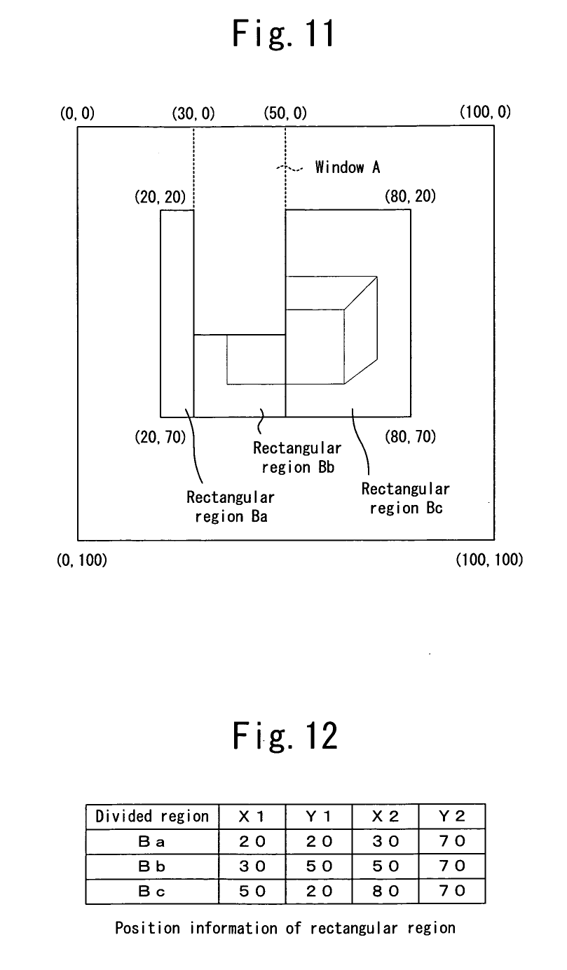

It will be described more specifically. FIG. 10 shows an example screen of the operation screen in which the windows registered in the window position management table 32 in FIG. 9 are displayed. In the example screen, the window B is the modeling window and is registered in the window management table 31 shown in FIG. 8. The window A is displayed before the window B and a part of the window A overlaps with a part of the window B. The U-shaped region of the window B is not hidden by the window A. In this example, the remote control server module 28 divides the U-shaped region into a plurality of rectangular regions. FIG. 11 shows the respective rectangular regions obtained by the dividing process. As shown in FIG. 11, the remote control server module 28 divides the U-shaped region shown in FIG. 10 into the rectangular region Ba at the left side of the window A, the rectangular region Bb at the lower side of the window A, and the rectangular region Bc at the right side of the window A. FIG. 12 is a table showing position information (X-Y coordinate values of the upper-left corner and X-Y coordinate values of the lower-right corner) of the rectangular regions Ba, Bb, and Bc divided by the dividing process.

The remote control server module 28 creates position information of rectangular regions as shown in FIG. 12 at step S137 in the dividing process. Then, the remote control server module 28 transmits the window ID and the position information of the rectangular regions with respect to the target window to the remote control client module 18 of the web client device 10 through the RDP communication or the ICA communication (S138). The process executed by the remote control client module 18 when the window ID and the position information of the rectangular regions will be described below.

After transmitting the window ID and the position information of the rectangular regions, the remote control server module 28 determines whether the processes at steps S137 and S138 have been executed for all the modeling windows that are partially hidden by the window defined by the window contents data or not (S139). If there is an unfinished modeling window that is not processed (S139; NO), the remote control server module 28 specifies one unfinished modeling window as a target and executes steps S137 and S138 again.

The processes at steps S137 and S138 have been executed for all the modeling windows (S139; YES), the remote control server module 28 restarts the above-described process loop (FIG. 4, S106; NO, S107; NO, S108; NO).

Next, the contents related to the present invention among the processes executed by the web client device 10 will be described.

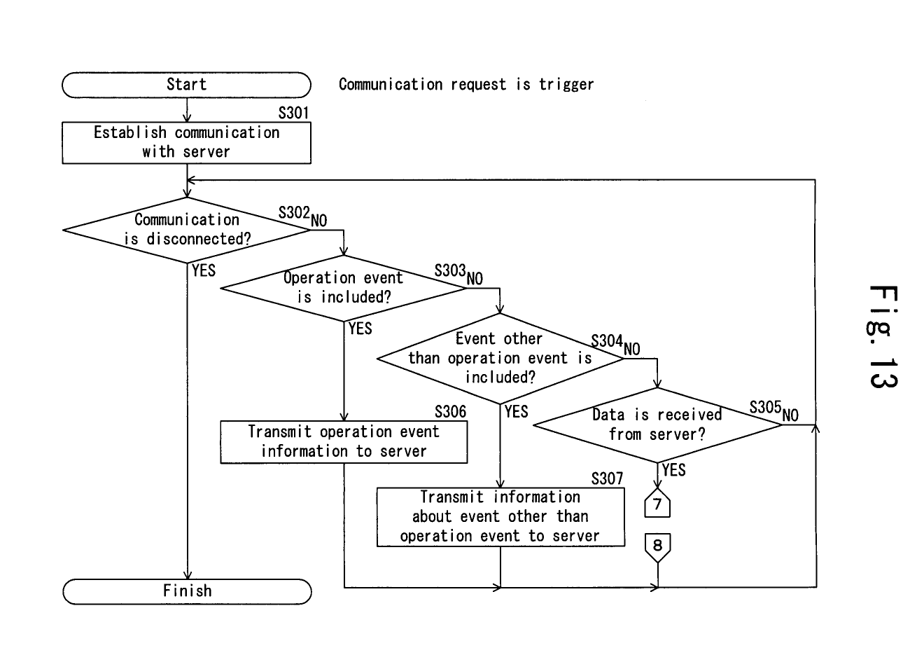

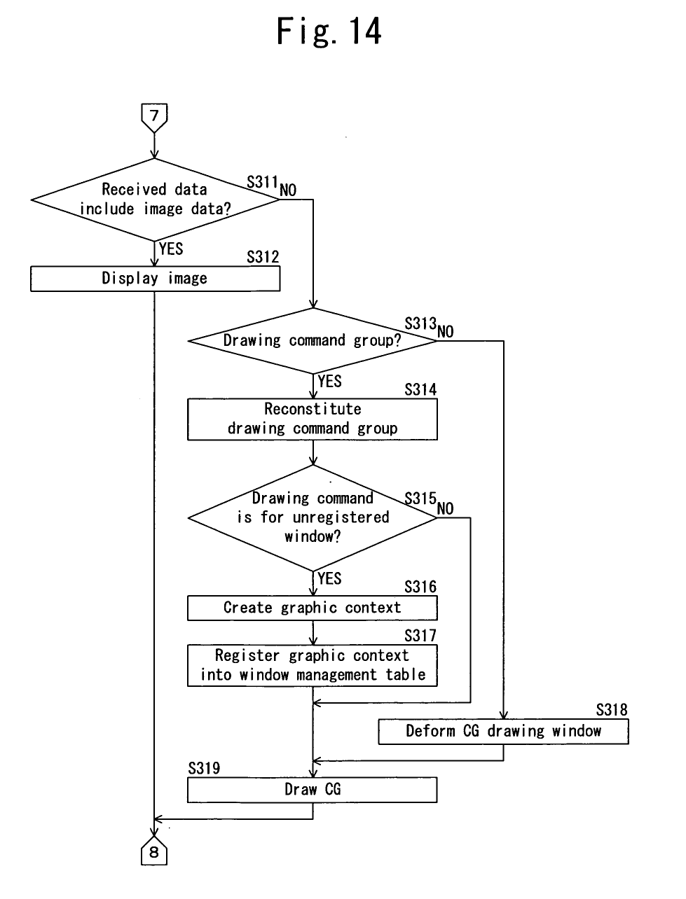

The remote control client module 18 of the web client device 10 is started by a trigger when the remote control server module 28 executing step S102 in FIG. 4 requests to establish the RDP communication or the ICA communication. FIG. 13 and FIG. 14 are flowcharts showing a process executed by the CPU 11 according to the remote control client module 18.

After starting the process, the remote control client module 18 (the CPU 11 according to the module 18) establishes communication with the remote control server module 28 (S301), and then, waits until disconnection of the communication with the remote control server module 28, generation of an operation event, generation of an event other than the operation events, and data reception from the remote control server module 28 (S302; NO, S303; NO, S304; NO, S305; NO).

When the remote control server module 28 requests the disconnection of the communication (S302; YES) during the process loop's execution (S302; NO, S303; NO, S304; NO, S305; NO), the remote control client module 18 finishes the process shown in FIG. 13 and FIG. 14.

Further, when an operation event such as a click, a drag and a key input is generated (S303; YES) during the process loop's execution (S302; NO, S303; NO, S304; NO, S305; NO), the remote control client module 18 executes the process to transmit the operation event information representing the operation event to the remote control server module 28 through the RDP communication or the ICA communication (S306), and restarts the above-described process loop (S302; NO, S303; NO, S304; NO, S305; NO).

Still further, when an event other than the operation events is generated (S304; YES) during the process loop's execution (S302; NO, S303; NO, S304; NO, S305; NO), the remote control client module 18 executes the process to transmit the information about the event other than the operation events to the remote control server module 28 through the RDP communication or the ICA communication (S307), and restarts the above-described process loop (S302; NO, S303; NO, S304; NO, S305; NO).

Yet further, when data is received from the remote control server module 28 through the RDP communication, the ICA communication, or the communication according to the above-described original protocol S305; YES) during the process loop's execution (S302; NO, S303; NO, S304; NO, S305; NO), the remote control client module 18 determines whether the received data includes image data or not (S311).

When the received data includes image data (S311; YES), the remote control client module 18 executes the process to display an image based on the image data in a region defined by the position information included in the received data (S312), and restarts the above-described process loop (S302; NO, S303; NO, S304; NO, S305; NO).

On the other hand, when the received data does not include image data (S311; NO), the remote control client module 18 determines whether the received data includes a record that is deformed from the drawing command group into the transmitting form or not (S313).

Then, when the received data includes a record that is deformed from the drawing command group into the transmitting form (S313; YES), the remote control client module 18 executes the process to reconstitute the drawing command group from the transmitting data (S314).

Next, the remote control client module 18 determines whether the drawing command group has a function to draw CG in an unregistered window or not (S315).

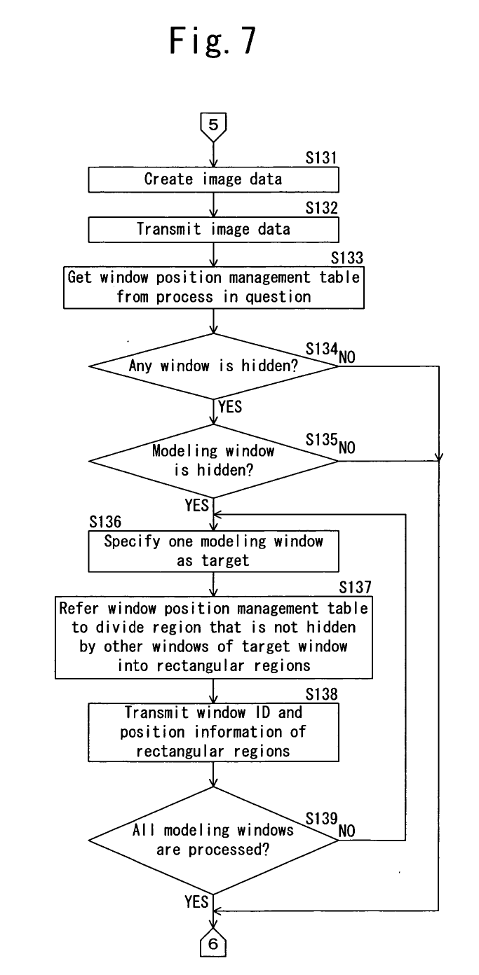

When the drawing command group has a function to draw CG on an unregistered window (S315; YES), the remote control client module 18 creates graphic context to define that the three-dimensional model is drawn by the command group in the window (S316), and registers the graphic context into the window management table (S317). Further, the data structure of the window management table is similar to that of the window management table shown in FIG. 7, and each record in the window management table has a field for recording an ID that is the same the window ID of the server side in FIG. 7 and a field for recording a storing position of the graphic context created at the client side.

After registering the graphic context into the window management table, the remote control client module 18 executes a process to draw CG of the three-dimensional model according to the drawing command group in the window defined by the window ID of the drawing command group as the CG drawing region (S319). Then, the remote control client module 18 restarts the above-described process loop (S302; NO, S303; NO, S304; NO, S305; NO).

On the other hand, when the drawing command group does not have a function to draw CG on an unregistered window (S315; NO), the remote control client module 18 executes a process to draw CG of the three-dimensional model according to the drawing command group without executing a process to create and register a graphic context (S319), and restarts the above-described process loop (S302; NO, S303; NO, S304; NO, S305; NO).

Further, when the received data does not include the record that is deformed from the drawing command group into the above-described transmitting form (S313; NO), since the received data includes the rectangular position information, the remote control client module 18 executes a process to deform the CG drawing region in the window included in the received data (S318). In an example shown in FIG. 10 and FIG. 11, the remote control client module 18 leaves an U-shaped portion including the rectangular regions Ba, Bb and Bc defined by the rectangular region position information in the CG drawing region shown by the window ID included in the received data (the region of the window B in FIG. 10) and removes the other region (the portion overlapped with the window A in FIG. 10) from the CG drawing region.

After executing the deforming process for the CG drawing region, the remote control client module 18 executes the process for drawing CG of the three-dimensional model in the CG drawing region (S319) and restarts the above-described process loop (S302; NO, S303; NO, S304; NO, S305; NO).

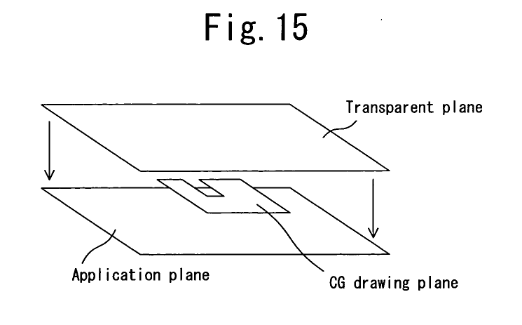

The CG drawing region in which the CG is drawn at step S319 is, as shown in FIG. 15, located on the CG drawing plane arranged between the transparent plane for detecting mouse input and key input, and the application plane on which the screen image including the window B for the three-dimensional model and the window A are displayed.

Next, functions and effects of the computer network system of the embodiment will be described.

When the operator of the web client device 10 accesses the web application server device 20 through the web browser 17 with designating the URL including the execution instruction command of the CAD application 29 in order to remotely control the CAD application 29 in the web application server device 20, the screen image for operating the CAD application 29 is displayed in the window of the web browser 17 (S101 through S105). The transparent plane for detecting mouse input and key input is located before the screen image as described above. When the operator of the web client device 10 inputs any signal by an operation of the mouse or keyboard on the transparent plane to operate the CAD application 29, the content of the operation event is transmitted to the CAD application 29 through the functions of the remote control client module 18 and the remote control server module 28, and then, the screen image whose display contents are changed according to the operation event is displayed on the window of the web browser (S303; YES, S306, S108; YES, S121 through S125). In this way, the CAD application 29 is remotely operated through the web browser.

When an instruction to open a window for making (modeling) the three-dimensional model is provided on the operation screen of the CAD application 29 of the web client device 10 in the middle of exchanging the operation event and the screen image data, the web application server device 20 transmits the drawing command for drawing the CG to the web client device 10, not the screen image data after drawing CG of the three-dimensional model in the window for the three-dimensional model (S303; YES, S306, S108; YES, S121, S122, S123; YES, S124, S125, S126; YES, S127, S128). Receiving the drawing command, the web client device 10 draws CG of the three-dimensional model using its own graphic accelerator (S305; YES, S311; NO, S313; YES, S314 through S317, S319).

According to the embodiment, since the process to draw CG of the three-dimensional model is executed by the graphic accelerator of the web client device 10, not by the graphic accelerator of the web application server device 20, the web client device 10 can draw CG of the three-dimensional model at high speed.

Further, when an instruction to display a window other than the modeling window (a making (drafting) window for a two-dimensional model or a GUI part such as a drop-down list box) is provided on the operation screen of the CAD application 29 displayed on the web client device 10, the web application server device 20 transmits image data of the window image to the web client device 10 and the window is displayed on the web client device 10 (S303; YES, S306, S108; YES, S121, S122, S123; NO, S131, S132, S311; YES, S312). At that time, if a part of the modeling window is overwritten by the new window, the CG drawing region in the modeling window is deformed so that the CG of the three-dimensional model is drawn in a region that is not overwritten by the new window (S134; YES, S135; YES, S136 through S139, S305; YES, S311; NO, S313; NO, S318). Therefore, a drafting window or a GUI part such as a drop-down list box is displayed as if to be located before the modeling window. Nevertheless, the CG of the three-dimensional model is drawn in high speed by the graphic accelerator of the web client device 10.

What is claimed is:

1. A web application system that remotely controls a modeling application in a web application server device through an operation in a web browser window of one or more web client devices, said web application server device comprising:
a screen image data transmitting section for transmitting screen image data that displays an image of a screen for operating said modeling application to a web client device at a request from said web client device;
an operation receiving section for receiving operation event information showing an operation event input on a screen of said web client device from said web client device;
a drawing command getting section for getting a drawing command to draw CG of a three-dimensional model from said modeling application when said operation event shown by said operation event information received by said operation receiving section relates to said three-dimensional model to be displayed on said screen as CG; and
a drawing command transmitting section for transmitting said drawing command gotten by said drawing command getting section to said web client device, and
said web client device comprising:
a request transmitting section for transmitting a request to remotely control said modeling application to said web application server device when an input device accepts said request;
a screen image displaying section for displaying a screen based on screen image data received from said web application server device;
an operation transmitting section for transmitting operation event information that shows an operation event input on said screen to said web application server device when said operation event is detected; and
a CG drawing section for drawing CG of a three-dimensional model in a region where a CG of a three-dimensional model should be drawn in said screen based on said drawing command received from said web application server device.

2. A web application server device in a web application system, said device comprising:
a screen image data transmitting section for transmitting screen image data that displays an image of a screen for operating a modeling application to a web client device through a communication device when a request is received from said web client device in one or more web client devices connected through said communication device;
an operation receiving section for receiving operation event information showing an operation event input on a screen of said web client device from said web client device through said communication device;
a drawing command getting section for getting a drawing command to draw CG from said modeling application when said operation event shown by said operation event information received by said operation receiving section relates to a three-dimensional model to be displayed on said screen as CG; and
a drawing command transmitting section for transmitting said drawing command gotten by said drawing command getting section to said web client device through said communication device.

3. The web application server device according to claim 2, further comprising:
a screen data getting section for getting screen data from said modeling application to display a screen after a process corresponding to said operation event is finished when said operation event shown by said operation event information received by said operation receiving section is an event other than operation events about three-dimensional models whose CG should be displayed on said screen;
a screen image creating section for creating image data of the image of the screen shown by said screen data gotten by said screen data getting section; and
a screen image transmitting section for transmitting said image data created by said screen image creating section to said web client device through said communication device.

4. The web application server device according to claim 2, further comprising:
a display region specifying section for specifying a region that is not hidden by executing the operation event shown by the operation event information received by said operation receiving section as a CG drawing region for a three-dimensional model when said operation event hides a part of the region in which a three-dimensional model should be displayed and said operation event is different from operation events about a three-dimensional model; and
a display region transmitting section for transmitting information to define said CG drawing region specified by said display region specifying section to said web client device through said communication device.

5. The web application server device according to claim 4, wherein said display region transmitting section divides said CG drawing region specified by said display region specifying section into a plurality of rectangular regions and transmits information about positions of said rectangular regions as information to define CG display region.

6. A web client device in a web application system, said device comprising:
a request accepting section for accepting a request to remotely control a modeling application of a web application server device connected through a communication device when an operator inputs a request by an input device;
a request transmitting section for transmitting the request accepted by said request accepting section to said web application server device through said communication device;
a screen image displaying section for displaying an image on a screen based on screen image data received from said web application server device through said communication device;
an operation transmitting section for transmitting operation event information that shows an operation event input on said screen to said web application server device through said communication device when said operation event is detected; and
a CG drawing section for drawing CG of a three-dimensional model in a region where a CG of a three-dimensional model should be drawn in said screen based on a drawing command received from said web application server device through said communication device.
